(19) United States
(12) Patent Application Publication
(10) Pub. No.: US 2025/0053660 A1
(43) Pub. Date: Feb. 13, 2025

(54) SYSTEM AND METHOD TO DYNAMICALLY AND HOLISTICALLY MEASURE THE RISK LEVEL OF A DEVICE

(71) Applicant: Google LLC, Mountain View, CA (US)

(72) Inventor: Karan Dwivedi, Fremont, CA (US)

(21) Appl. No.: 18/231,714

(22) Filed: Aug. 8, 2023

(51) Int. Cl. G06F 21/57; G06F 21/55

(52) U.S. Cl. CPC G06F 21/577; G06F 21/554

(57) ABSTRACT

Systems and methods for measuring the risk level of a device are provided. Vulnerability-related metrics of a plurality of applications hosted by a user device are collected by a process of the user device. Based on the vulnerability-related metrics of the plurality of applications hosted by the user device, a risk level of the user device is determined. Responsive to determining that the risk level satisfies a criterion, a security-based action associated with the user device is performed.

### TECHNICAL FIELD

Aspects and implementations of the present disclosure relate to computer security, and in particular to dynamically and holistically measure the risk level of a device.

### BACKGROUND

Mobile devices have become an integral part of daily life, facilitating communication, productivity, and entertainment. The widespread adoption of mobile devices has revolutionized how individuals interact with the world around them. However, this surge in mobile device usage has spurred an increase in exploits seeking to take advantage of device vulnerabilities. An exploit can be a piece of software, a sequence of commands, or a technique that, when executed, takes advantage of a software bug, glitch, vulnerability, or a system's design to cause unintended intrusive activity or to perform unauthorized actions. When used maliciously, exploits can pose severe risks to the confidentiality, integrity, and availability of sensitive information stored on and transmitted through mobile devices. Additionally, exploits can lead to interruption or inefficient operation of the device, can damage the device or the data stored thereon, potentially causing financial loss and other losses and liabilities for the user of the device.

Intrusive activity that results from exploits can include, for example, malware, phishing, ransomware, and network and device level eavesdropping. Exploits can comprise the security of devices and the data to which they have access. Furthermore, the rapid expansion of Internet of Things (IoT) devices and the growing reliance on mobile connectivity for critical operations have amplified the potential impact of exploits. Devices vulnerable to certain exploits can transmit the exploits to devices with which it is connected.

### SUMMARY

The below summary is a simplified summary of the disclosure in order to provide a basic understanding of some aspects of the disclosure. This summary is not an extensive overview of the disclosure. It is intended neither to identify key or critical elements of the disclosure, nor delineate any scope of the particular implementations of the disclosure or any scope of the claims. Its sole purpose is to present some concepts of the disclosure in a simplified form as a prelude to the more detailed description that is presented later.

In some implementations, a system and method are disclosed for measuring the risk level of a device. In an implementation, a method includes collecting, by a processor of a user device of a user, vulnerability-related metrics of a plurality of applications hosted by the user device. The method further includes determining, by the processor of the user device and based on the vulnerability-related metrics of the plurality of applications hosted by the user device, a risk level of the user device. The method further includes, responsive to determining that the risk level satisfies a criterion, performing, by the process of the user device, a security-based action associated with the user device. In some implementations, the method further includes determining the risk level of the user device in response to a triggering event.

In some implementations, the vulnerability-related metrics can include identified current vulnerabilities associated with the user device, a current location of the user device, network activity associated with the user device, and/or one or more websites accessed on the user device. In some implementations, the security-based action can include sending a first notification to the user of the user device, sending a second notification to an application running on the user device, and/or sending a third notification to a second user device connected to the user device.

In some implementations, the method further includes determining a risk score by calculating an average of the vulnerability-related metrics, each vulnerability-related metric weighted by a corresponding weighting value. The method further includes determining the risk level of the user device based on the risk score.

In some implementations, the method further includes sending a request to a second user device and receiving, from the second user device, a second request requesting the risk level of the user device. The method further includes providing, to the second user device, the risk level of the user device. The method further includes receiving, from the second user device, a notification of whether the request has been granted or denied in view of the risk level of the user device.

In some implementations, the method further includes receiving, from a second user device, a request to access the user device. The request can include a risk level of the second user device. The method further includes, responsive to determining that the risk level of the second user device satisfies a second criterion, denying the request from the second user device to access the user device.

An aspect of the disclosure provides a system including a memory device and a processing device communicatively coupled to the memory device. The processing device performs operations that include collecting vulnerability-related metrics of a plurality of applications hosted by a user device of a user. The processing device performs operations further including determining, based on the vulnerability-related metrics of the plurality of applications hosted by the user device, a risk level of the user device. The processing device performs operations further including, responsive to determining that the risk level satisfies a criterion, performing a security-based action associated with the user device. In some implementations, the processing device performs operations further including determining the risk level of the user device in response to a triggering event.

In some implementations, the vulnerability-related metrics can include identified current vulnerabilities associated with the user device, a current location of the user device, network activity associated with the user device, and/or one or more websites accessed on the user device. In some implementations, the security-based action can include sending a first notification to the user of the user device, sending a second notification to an application running on the user device, and/or sending a third notification to a second user device connected to the user device.

In some implementations, the processing device performs operations further including, determining a risk score by calculating an average of the vulnerability-related metrics, each vulnerability-related metric weighted by a corresponding weighting value. The processing device performs operations further including determining the risk level of the user device based on the risk score.

In some implementations, the processing device performs operations further sending a request to a second user device, and receiving, from the second user device, a second request requesting the risk level of the user device. The processing device performs operations further including providing, to the second user device, the risk level of the user device. The processing device performs operations further including receiving, from the second user device, a notification of whether the request has been granted or denied in view of the risk level of the user device.

In some implementations, the processing device performs operations further including receiving, from a second user device, a request to access the user device. The request can include a second risk level of the second user device. In some implementations, the processing device performs operations further including, responsive to determining that the second risk level of the second user device satisfies a second criterion, denying the request from the second user device to access the user device.

An aspect of the disclosure provides a computer-readable storage medium (which may be a non-transitory computer-readable storage medium, although the disclosure is not limited to that) stores instructions which, when executed, cause a processing device to perform operations including collecting vulnerability-related metrics of a plurality of application hosted by a user device of a user. The processing device performs operations further including determining, based on the vulnerability-related metrics of the plurality of applications hosted by the user device, a risk level of the user device. The processing device performs operations further including, responsive to determining that the risk level satisfies a criterion, performing a security-based action associated with the user device. In some implementations, the processing device performs operations further including determining the risk level of the user device in response to a triggering event.

In some implementations, the vulnerability-related metrics can include identified current vulnerabilities associated with the user device, a current location of the user device, network activity associated with the user device, and/or one or more websites accessed on the user device. In some implementations, the security-based action can include sending a first notification to the user of the user device, sending a second notification to an application running on the user device, and/or sending a third notification to a second user device connected to the user device.

In some implementations, the processing device performs operations further including determining a risk score by calculating an average of the vulnerability-related metrics. In calculating the average, each vulnerability-related metric can be weighted by a corresponding weighting value. The processing device performs operations further including determining the risk level of the user device based on the risk score.

In some implementations, the processing device performs operations further including sending a request to a second user device, and receiving, from the second user device, a second request requesting the risk level of the user device. The processing device performs operations further including providing, to the second user device, the risk level of the user device. The processing device performs operations further including receiving, from the second user device, a notification of whether the request has been granted or denied in view of the risk level of the user device.

In some implementations, the processing device performs operations further including receiving, from a second user device, a request to access the user device. The request can include a second risk level of the second user device. The processing device performs operations further including, responsive to determining that the second risk level of the second user device satisfies a second criterion, denying the request from the second user device to access the user device.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example system architecture, in accordance with at least one embodiment of the present disclosure.

FIG. 2 depicts an example risk level measurement system, in accordance with at least one embodiment of the present disclosure.

FIG. 3 is a flow diagram of an example method for measuring the risk level of a device, in accordance with at least one embodiment of the present disclosure.

FIG. 4 is a block diagram illustrating an exemplary computer system, in accordance with at least one embodiment of the present disclosure.

### DETAILED DESCRIPTION

Aspects of the present disclosure relate to measuring the risk level of a device. A device can be a mobile phone, an Internet of Things (IoT) device, a tablet, or any other device. These devices can be vulnerable to exploits, such as installation and operation of malware, accessing or attempting to access the device without permission or authorization, modifying or exfiltrating data stored on the device without permission or authorization, exhausting computing resources of the device (e.g., denial of service attacks), and/or other forms of unwanted activity. Furthermore, these devices can communicate with other devices, e.g., by sending data (e.g., sharing a file or picture), exchanging messages, requesting access (e.g., for peripheral use, authentication, tethering or a hotspot, making a payment, etc.), etc. Device communication with a device that is vulnerable to exploits can pose a security risk. For example, an application hosted by a mobile device can include malware designed to spread to other devices. As a result, the malware can propagate to other devices with which the mobile device communicates.

Device vulnerabilities are often concealed, and a user of the device may not know of the particular vulnerabilities of the device. As a result, a user of a mobile device may not be aware that a device with which the mobile device communicates poses a security threat. While the vulnerabilities of the device itself pose a potential security threat to the device, the device may also spread the potential security risk to other devices, without the users' knowledge. For example, a mobile device, such as a smartphone, may host an application that is known to be vulnerable to certain exploits. However, the user of the mobile device may not be aware that the application is vulnerable to these exploits. The user may then share data with another device, and inadvertently transmit the exploits to the other device along with the shared data. Furthermore, the device receiving the data may be unaware that the device from which it is receiving data is vulnerable to the particular exploits. Considering the multiple applications running on a device, the sensitive data being stored on the device, and communications with other devices (e.g., file transfers, message communications, etc.), without a method to track the risk level of the device, the likelihood of unknowingly being vulnerable to, and/or of spreading, exploits is high.

Aspects of the present disclosure address the above-noted and other deficiencies by measuring the risk level of a device, and implementing security-based actions in view of the measured risk level. A device can be vulnerable to exploits for a number of reasons, such as, not installing the latest operating system and security updates, the device being rooted, the device communicating with an untrusted device (e.g., by sending or receiving files with the untrusted device), and/or by being compromised (e.g., network activity can indicate connections to a known attacker server, infected by a known virus). In some embodiments, an agent installed on the operating system of the device can monitor device activity, e.g., by monitoring the applications hosted by the device. The device activity can be user initiated and/or non-user initiated. For example, the applications monitored by the agent can be stock applications that are automatically installed on the device (e.g., at manufacturing time), applications installed by a user of the device, and/or applications installed without the user's knowledge (e.g., malware). The agent can monitor components of the device other than user-installed applications, such as device drivers, services, firmware, middleware, plug-ins and extensions, etc. By monitoring the device activity, the agent can gather vulnerability-related metrics that are related to the applications hosted by the device and/or other components running on the device. The agent can determine a risk score of the device by calculating a particular statistic (e.g., the weighted average, the weighted sum, etc.) of the vulnerability-related metrics. Examples of the vulnerability-related metrics can include, for example, websites accessed, network activity, current location of the device, and/or other current vulnerabilities (e.g., outdated operating system version, outdated applications, outdated security updates, device is rooted, presence of known malware, etc.). The vulnerability-related metrics can reflect the status of the user device at a point in time (e.g., when the metric is collected). In some embodiments, the vulnerability-related metrics can reflect device activity that occurred over a period of time. The period of time can be, for example, the time period since the vulnerability-related metric was last calculated, or can be a specified time period (e.g., the last two minutes).

Each vulnerability-related metric can have a corresponding weighting value. The weighting value can represent the seriousness of the vulnerability, and can be set by the organization that supports the device. That is, an organization can set the weights of each vulnerability-related metric based on the threat each metric poses to the organization's security. For example, an organization that is susceptible to threats related to location can set the location metric weight higher than an organization that may not be as susceptible to location-related threats. As another example, an organization may determine that certain network activity vulnerabilities pose a more serious threat to security than the location of the device, and thus may assign a higher weight to network activity related metrics than to location related metrics. In some embodiments, once the organization has set the weight values for the vulnerability-related metrics, the weight values may not change. In other embodiments, the organization can adjust the weight values, on a predetermined schedule (e.g., once a year), and/or in response to an event (e.g., revisions to the organization's security policies). In yet some other embodiments, the weight values can be set/updated automatically based on a type of an organization (e.g., a bank, a sociate networking service, a health care service, etc.) and/or other factors (acquisition of another company, change in security policies, etc.).

In some embodiments, the agent can determine the risk score on a predetermined schedule (e.g., every three minutes), and/or in response to a triggering event (e.g., user activity, or in response to a request to calculate the risk score). In some embodiments, the predetermined schedule for calculating the risk score can vary depending on whether a user is actively using the device. For example, while a user is actively using the device, the agent can calculate the risk score every ten minutes, and while the user is not actively using the device, the agent can calculate the risk score once an hour. In some embodiments, the request to calculate the risk score can come from user input, from an application running on the device, and/or from another device that may be attempting to communicate with the device.

In some embodiments, the risk score can indicate an overall risk level for the device. The risk level can correspond to a risk score range. For example, a low risk level can correspond to a risk score between 0 and 33 (inclusive), a medium risk level can correspond to a risk score between 34 and 65 (inclusive), and a high risk level can correspond to a risk score of 66 and above.

In view of the risk level, the agent can perform a security-based action. The security-based action can include notifying a user of the device of the risk level, notifying applications running on the device of the risk level, notifying a system administrator of an organization with which the user of the device is associated, and/or sending the risk level to other devices with which the device is communicating (or attempting to communicate). In some embodiments, the agent can prevent certain operations on the device in view of the risk level. For example, if the risk level is above a certain threshold, the agent can prevent the device from communicating with other devices to avoid spreading a security threat to the other devices.

In some embodiments, the agent can send a notification to the user of the device indicating the risk level, and can optionally indicate the device activity that contributed to the risk level. In some embodiments, the agent can provide suggestions of actions the user can take to improve the risk level of the device. In some embodiments, the agent can maintain historical data of the risk level, and can provide an overview of the historical risk levels of the device. The overview can cover the last 30 days of device activity, for example. A user can use such information to determine what type of activity resulted in lowering or increasing the device's risk level.

Aspects of the present disclosure provide technical advantages over previous solutions. Aspects of the present disclosure can provide improved vulnerability detection by dynamically and holistically measuring the risk level of a device. Embodiments described herein can provide improved accuracy and efficiency when detecting device vulnerabilities, and can take proactive action that can inhibit the distribution of security threats that exploit the detected vulnerabilities. As a result, devices can be subject to fewer security threats and exploits, thus enhancing device security. Techniques described herein can provide more efficient detection and prevention of vulnerabilities by performing security-based actions based on a measured risk level (or risk score) of the device. Techniques described herein can improve the functioning of user devices by preventing certain activities from occurring in view of the risk level of the device. For example, a sensitive application (e.g., banking related) can verify the risk level of the user device prior to completing installation on the user device, and/or can prevent sensitive operations (e.g., money transfers) from taking place on the user device in view of the risk level of the user device. As another example, websites can deny access requests received from a user device with a high risk level, which can prevent attack propagation (e.g., if the high risk device is part of a botnet network that is responsible for a denial of service attack, the website can directly deny the connection request from the high risk device). As another example, an organization can prevent access to essential resources in view of the risk level of the device attempting to access the resources. As another example, applications hosted by the device can enable communication with other devices (e.g., IoT devices) only if the risk level of the device is low enough (e.g., an application on a mobile phone that is used to unlock a door can enable the door to be unlocked only if the risk level of the mobile phone is low; an application on a mobile phone that is used to interact with a vacuum bot that has a video camera can disable the application if the risk level of the mobile phone is medium or above). Thus, techniques described herein can prevent exploits from executing on a user's device and from being propagated to other devices.

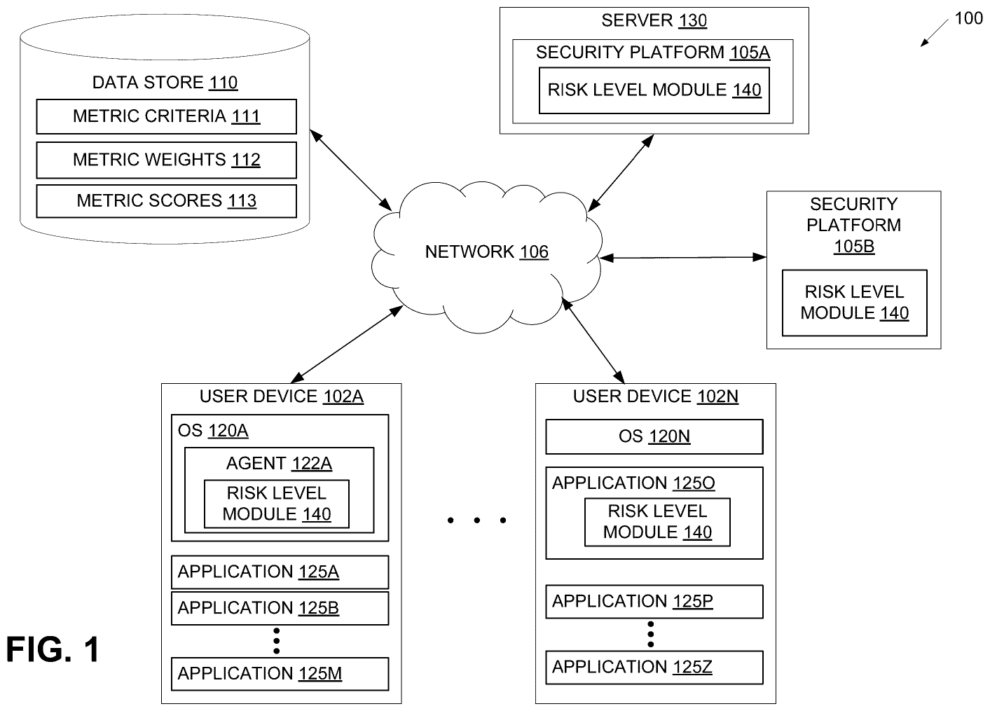

FIG. 1 illustrates an example system architecture 100, in accordance with at least one embodiment of the present disclosure. The system architecture 100 includes user devices 102A-N, security platform 105, a data store 110, and/or a server 130, each connected to a network 106. Network 106 can include a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof.

In some embodiments, data store 110 is a persistent storage that is capable of storing metric criteria 111, metric weights 112, and/or metric scores 113, as well as data structures to tag, organize, and index the stored data. Data store 110 may be hosted by one or more storage devices, such as main memory, magnetic or optical storage based disks, tapes or hard drives, NAS, SAN, and so forth. In some implementations, data store 110 may be a network-attached file server, while in other embodiments data store 110 may be some other type of persistent storage such as an object-oriented database, a relational database, and so forth, that may be hosted by security platform 105A,B, and/or user device 102A-N. In some embodiments, data store 110 may be hosted by or one or more different machines coupled to the server 130, security platform 105B, and/or user devices 102A-N.

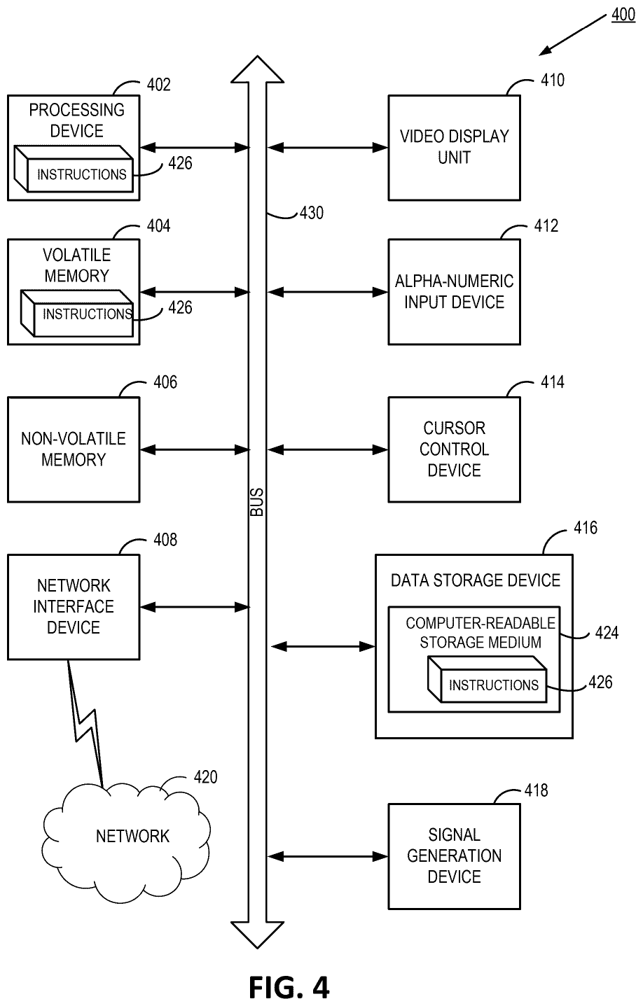

User devices 102A-N can include computing devices such as personal computers (PCs), laptops, mobile phones, smart phones, tablet computers, netbook computers, network-connected televisions, digital assistants, servers, networking equipment, or any other computing devices. FIG. 4 illustrates an example architecture of a user device 102A-N. In some embodiments, user devices 102A-N can also be referred to as “client devices.” A user device 102A-N can include an operating system 120A-N, and any number of applications 125A-Z. In some embodiments, an agent 122 can run on an operating system 120A. Agent 122 can refer to a software component or program that performs specific tasks or functions on behalf of the operating system 120A. In some embodiments, agent 122 can include the risk level module 140, which can measure the risk level of the corresponding user device 102A. Agent 122 can have system-level permissions, and can detect device activity, e.g., by listening for device events and information.

In some embodiments, an application 1250 hosted on user device 102N can perform the functions (or some of the functions) of the risk level module 140. In some embodiments, application 1250 can have high-level permissions that enable application 1250 to detect device activity, e.g., by listening for device events and information. In some embodiments, risk level module 140 (or parts of risk level module 140) can execute as part of a security platform 105A,B. In some embodiments, security platform 105A can run on server 130. In some embodiments, security platform 105B can be hosted by a cloud computing platform (not depicted). In some embodiments, security platform 105A,B can provide dedicated security features for each user device 102A-N.

In such embodiments, risk module 140 can seek permissions to retrieve device information, such as network connections, websites accessed, wireless provider in use, current device location, SMS sent and received, list of applications installed, results of a scan of the device against a current set of known vulnerabilities, etc. In some embodiments, the risk module 140 can use external data sources (such as a publicly available external virus scanner) using application programming interfaces (APIs) to collect context regarding the data stored on the device. For example, the risk module 140 can use an external antivirus engine to determine the safety of IP addresses and domains accessed by the user device 102A-N. Risk module 140 can also scan other applications and files present on the user device using the virus scanner for anti-malware checks.

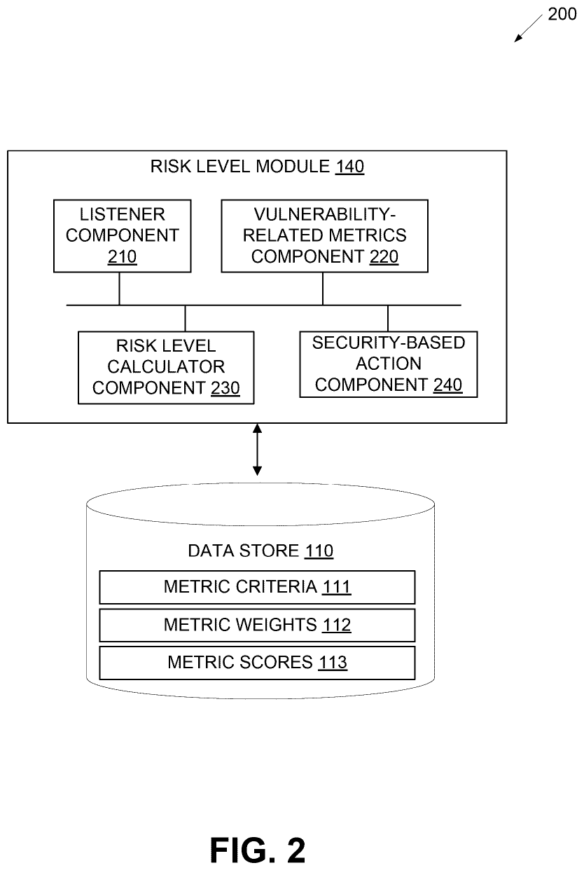

In some embodiments, the risk module 140 can monitor the device activity of the corresponding user device 102A-N to collect vulnerability-related metrics data. The metric criteria 111 can define the vulnerability-related categories of metrics for which the risk module 140 can monitor. The vulnerability-related categories can include, for example, device location, network activity (IP and domains accessed), websites accessed, virus scan results, current operating system version installed on the user device 102A-N, whether any of the applications 125A-Z hosted by the user device 102A-N are not up to date, whether the operating system 120A-N has been rooted, and/or other vulnerability-related metrics that pose a threat to the user device 102A-N and/or to other devices connected to user device 102A-N. The vulnerability-related categories are not limited to the examples listed above. The risk module 140 can monitor the operating system 120A-N, the applications 125A-Z, and/or other services or programs running on the corresponding user device 102A-N, and can collect vulnerability-related metrics based on the categories defined by metric criteria 111. The risk module 140 can calculate a risk score for the corresponding user device 102A-N based on the collected vulnerability-related metrics. The risk score can be a weighted average of the collected vulnerability-related metrics, weighted by the weights 112. The calculated risk score can then be stored in metric scores 113. The risk module 140 is further described with respect to FIG. 2.

Security platform 105A,B can provide security services for measuring risk level of a user device 102A-N. In some embodiments, user device 102A-N can monitor for device activity, and can send the monitored device activity data to security platform 105A,B. In some embodiments, security platform 105A,B can monitor device activity on user devices 102A-N. Using the device activity data, security platform 105A,B can measure the risk score and/or risk level of the user device 102A-N. Security platform 105A,B can notify the corresponding user device 102A-N of the risk score and/or risk level, and/or can implement security-based actions on the user device 102A-N. In some embodiments, security platform 105A,B can provide dedicated security features for each user device 102A-N. In some embodiments, security platform 105A,B can perform the functions (or some of the functions) of risk module 140.

In situations in which the system discussed here collects personal information about users, or may make use of personal information, the users may be provided with an opportunity to control whether security platform 105 and/or risk level module 140 collects user information (e.g., information about a user's social network, social actions or activities, profession, network activity, websites accessed, virus scan results, a user's preferences, and/or a user's current location), or to control whether and/or how to receive content from the server 130 that may be more relevant to the user. In addition, certain data may be treated in one or more ways before it is stored or used, so that personally identifiable information is removed. For example, a user's identity may be treated so that no personally identifiable information may be determined for the user, or a user's geographic location may be generalized where location information is obtained (such as to a city, ZIP code, or state level), so that a particular location of a user cannot be determined. Thus, the user may have control over how information is collected about the user and used by security platform 105A,B, risk level module 140, agent 122A, application 125A-Z, and/or server 130.

FIG. 2 depicts an example risk level measurement system 200, according to at least one embodiment of the present disclosure. The risk level measurement system 200 can include a risk level module 140 and one or more data stores 110. The risk level module 140 can access data store 110, e.g., via network 106 of FIG. 1. The risk level module 140 can include a listener component 210, a vulnerability-related metrics component 220, a risk level calculator component 230, and/or a security-based action component 240.

Data store 110 can store metric criteria 111, metric weights 112, and/or metric scores 113. Metric criteria 111 can define the vulnerability-related metrics used to determine the risk score and/or risk level of a device. For example, metric criteria 111 can include a list of vulnerability-related categories, and can include the criteria by which the vulnerability is measured. Examples of vulnerability-related categories include device location, network activity, and/or current vulnerabilities. Metric criteria 111 can store criteria for other vulnerability-related categories not listed here. The metric criteria for current vulnerabilities can include, for example, the number of applications that are not updated, whether the device is vulnerable to known exploits, whether the operating system is rooted, etc. Metric criteria 111 can provide a range of scores for each metric. Metric weights 112 can store the values used to determine the weighted average of the vulnerability-related metrics. Metric scores 113 can store the calculated risk score and/or risk level of a device (e.g., user device 102A-N of FIG. 1).

Listener component 210 can listen for events and information of a device (e.g., user device 102A-N of FIG. 1). The events and information can include, for example, network connections, websites accessed, wireless provider, device location, SMS sent and received, list of applications installed, the results of a scan of the user device against a current set of known vulnerabilities, etc. Listener service 210 can have a high level of permissions in order to monitor the applications, services, and/or other components running on the corresponding user device 102A-N. The services monitored by listener component 210 can be background services that can perform tasks such as network connectivity, location services, push notifications, synchronization with cloud services, and/or other such services. Other components monitored by the listener component 210 can include, for example, such as drivers that facilitated communication between the hardware components and the operating system 120. Listener component 210 can perform a number of functions to listen for events and/or to gather information. For example, listener component 210 can periodically poll or query components of user device 102 to check for changes or updates. As another example, listener component 210 can generate hardware interrupts for when specific conditions occur (e.g., a keypress on the keyboard, or a network connection/disconnection). The listener component 210 can register event handlers with the operating system 120, and the listener component 210 can be notified when such events occur. As another example, listener component 210 can use system calls provided by the operating system's API to access device information. Some operating systems 120 can provide notification APIs or frameworks that allow listener component 210 to register for specific events. When the event occurs, the operating system notifies the listener component 210 of the event. Thus, listener component 210 can listen for such notifications. In some embodiments, listener component 210 can interact with the operating system 120 directly to access low-level device information and events. In some embodiments, the listener component 210 can store the events and information locally on user device 102, and/or in data store 110.

The vulnerability-related metrics component 220 can use the metric criteria 111 to determine vulnerability-related metrics for the corresponding user device 102A-N. Based on the events and information detected by the listener component 210, the vulnerability-related metrics component 220 can identify the score corresponding to the collected data. In some embodiments, the vulnerability-related metrics component 220 can store the identified score locally (e.g., in volatile memory on the corresponding user device 102A-N), and/or in data store 110.

As an illustrative example, metric criteria 111 can define three metrics for which listener component 210 gathered data: location, network activity, and current vulnerabilities. In some embodiments, the metric criteria 111 can define fewer or more than three metrics for which listener component 210 gathers data. The listener component 210 can monitor the device for device activity corresponding to location, network activity, and/or current vulnerabilities. For example, device activity related to current vulnerabilities can include detecting an application (e.g., application 125A-Z of FIG. 1) that is out of date (e.g., for which a security update is available but has not yet been installed), device activity related to location can include detecting the location of the device, e.g., via a GPS service hosted on the user device, and device activity related to network activity can include detecting IP and domains accessed via applications 125A-Z. For example, for the location vulnerability-related metric, a score of 1 can represent a location of developed nations, a score of 3 can represent developing nations, a score of 6 can represent unsafe to travel locations, and as core of 9 can represent do-not-travel locations (e.g., active war zones). Thus, the vulnerability-related metrics component 220 can identify the score in metric criteria 111 in view of the data collected by listener component 210. As another example, for the network activity metric, a score of 1 can represent safe network activity, a score of 3 can represent note safe (e.g., not using SSL/TLS), a score of 6 can represent potentially infected, and a score of 9 can represent confirmed unsafe (e.g., part of known exploits). As another example, a vulnerability-related metric can be for current vulnerabilities, and a score of 0 can represent no vulnerabilities, a score of 2 can represent low severity vulnerabilities detected, a score of 4 can represent medium severity vulnerabilities detected, a score of 8 can represent high severity vulnerabilities detected, and a score of 10 can represent severe vulnerabilities detected.

Risk level calculator component 230 can determine the risk level for a corresponding user device 102A-N. Risk level calculator component 230 can determine a risk score for the user device 102A-N by calculating a weighted average of the vulnerability-related metric scores identified by vulnerability-related metric component 220. Risk level calculator component 230 can identify the weights assigned to each metric can from metric weights 112. Thus, the risk score for a user device 102A-N can be the weighted average of the vulnerability-related metrics scores corresponding to user device 102A-N, weighted by the corresponding metric weights 112.

For example, the calculation to determine the risk score for a device with three vulnerability-related metrics can be: (location weight×location score+network activity weight×network activity score+current vulnerabilities weight×current vulnerabilities score)=3. As an illustrative example, for a user device 102A-N for which the vulnerability-related metrics component 220 identified a location score of 1, a network activity score of 6, and a current vulnerabilities score of 10, the calculation can be: (1×location weight+6×network activity weight+10×current vulnerabilities weight)=3. Risk level calculator component 230 can identify the weight values from metric weights 112. As an illustrative example, the weight values for the location can be 8, for the network activity can be 10, and for the current vulnerabilities can be 9. Thus, the risk score in this illustrative example is: (1×8+6×10+10×9)=3=52.67. The risk level calculator component 230 can then store the calculated risk score in metric scores 113.

In some embodiments, the metric criteria 111 and/or the metric weights 112 can be defined by the manufacturer of the user device 102, the organization supporting the device 102, and/or the user of user device 102. The metric criteria 111 and/or the metric weights 112 can be set once upon initialization of the device, and/or during a manufacturing reset.

Risk level calculator component 230 can determine the risk level of the user device 102 in view of the risk score. In some embodiments, the risk level can correspond to a range of risk scores. As an illustrative example, a risk level of very low can correspond to risk scores between 0 and 20 (inclusive), a risk level of low can correspond to risk scores between 21 and 40 (inclusive), a risk level of medium can correspond to risk scores between 41 and 60 (inclusive), a risk level of high can correspond to risk scores between 61 and 80 (inclusive), and a risk level of severe can correspond to risk scores between 81 and 100 (inclusive). In this example, the vulnerability-related metrics are on a scale of 0-100, where 100 indicates the most severe vulnerabilities. It should be noted that other scales and ranges can be used to determine the risk score and/or risk level. In some embodiments, that the risk score ranges corresponding to the risk levels can be set by the manufacturer of the corresponding user device 102A-N, the organization supporting the corresponding device 102A-N, and/or the user of the corresponding user device 102A-N. The risk score ranges corresponding to the risk levels can be set once upon initialization of the device, and/or during a manufacturing reset. In some embodiments, a user of the user device 102 can update and/or adjust the risk score ranges corresponding to the risk levels.

Security-based action component 240 perform a security-based action in view of the risk level and/or risk score of the corresponding user device 102A-N. The security-based action can be, for example, sending a notification to a user of the user device, sending a notification to an application hosted by the user device, sending a notification to another component of the corresponding user device 102A-N (e.g., services, drivers, and/or other components of the user device), and/or second a notification to another user device connected to the corresponding user device 102A-N.

In some embodiments, security-based action component 240 can generate a notification corresponding to the risk level of the corresponding device 102A-N. The security-based action component 240 can transmit the notification to the user, to applications, and/or to other components of the user device 102. In some embodiments, the security-based action component 240 can provide a push notification in the user interface of the user device 102, indicating the risk level of the user device 102. The notification can optionally include suggested actions the user can take to improve the risk level of the device, such as update the operating system, uninstall an untrusted application, or reboot the device. In some embodiments, the security-based action component 240 can provide the push notification in the user interface indicating the risk level if the risk level is within a certain range (e.g., the risk level is high or severe). In some embodiments, the security-based action component 240 can transmit the risk level and/or the risk score to other components of the user device 102. For example, the security-based action component 240 can send the risk level and/or risk score to one of applications hosted by the user device 102. The application, in turn, can determine an action to perform in response to receiving the risk level and/or risk score. For example, a web browser application can determine to transmit the risk level along with the HTTP request, to indicate to the server hosting the website that risk level of the user device making the request. As another example, a messaging application can stop sending messages to other devices if the risk level is severe. In some embodiments, security-based action component 240 can transmit a notification indicating the risk level to another user device 102A-N, to enable the other user device 102A-N to determine whether to enable communications and/or access with the user device. As an illustrative example, the corresponding user device 102A-N can attempt to unlock the car doors of a user's car. The security-based action component 240 can transmit the risk level of the corresponding user device 102A-N to the device operating the car doors, and the device operating the car doors can determine whether to trust the corresponding user device 102A-N based on the risk level.

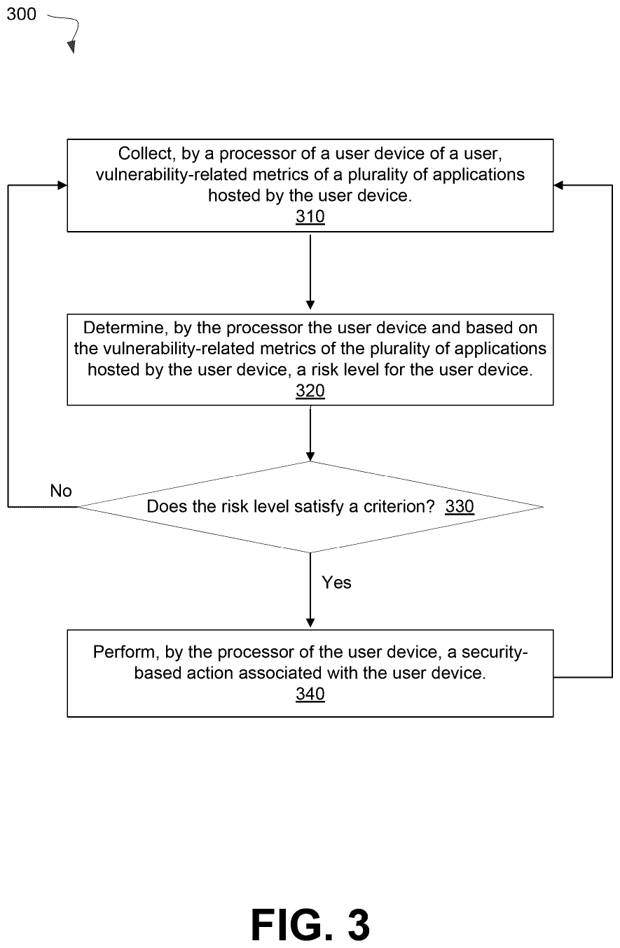

FIG. 3 is a flow diagram of an example method 300 for measuring the risk level of a device, according to at least one embodiment. Method 300 can be performed by processing logic that can include hardware (circuitry, dedicated logic, etc.), software (e.g., instructions run on a processing device), or a combination thereof. In at least one implementation, some or all of the operations of method 300 can be performed by one or more components of user device 102A-N of FIG. 1. In other implementations, some or all of the operations of method 300 can be performed by one or more components of server 130, and/or security platform 105A,B of FIG. 1.

For simplicity of explanation, the methods of this disclosure are depicted and described as a series of acts. However, acts in accordance with this disclosure can occur in various orders and/or concurrently, and with other acts not presented and described herein. Furthermore, not all illustrated acts can be required to implement the methods in accordance with the disclosed subject matter. In addition, those skilled in the art will understand and appreciate that the methods could alternatively be represented as a series of interrelated states, e.g., via a state diagram. Additionally, it should be appreciated that the methods disclosed in this specification are capable of being stored on an article of manufacture to facilitate transporting and transferring such methods to computing devices. The term “article of manufacture,” as used herein, is intended to encompass a computer program accessible from any computer-related device or storage media.

At block 310, processing logic collects, by a processor of a user device (e.g. user device 102A-N) of a user, vulnerability-related metrics of a plurality of applications (e.g., applications 125A-Z) hosted by the user device. In some embodiments, the vulnerability-related metrics can be current vulnerabilities associated with the user device, the current location of the user device, network activity associated with the user device, and/or website(s) accessed on the user device. It should be noted that additional vulnerability-related metrics not listed here can be collected by the processing logic.

At block 320, processing logic determines, based on the vulnerability-related metrics of the plurality of applications hosted by the user device, a risk level of the user device. In some embodiments, processing logic can determine the risk level in response to a triggering event. Additionally or alternatively, processing logic can determine the risk level on a predetermined schedule. For example, processing logic can determine the risk level in response to receiving a request to determine the risk level (e.g., from a user of the user device, from an application or separate component running on the user device, and/or as part of a request from a second user device). As another example, processing logic can determine the risk level in response to detecting user activity. User activity can include user-initiated activity and non-user-initiated activity. Examples of user-initiated activity can include moving the user device from one geographic location to another, downloading a new application, visiting a website, transferring files with another user device, etc. Examples of non-user-initiated activity can include device automatic updates of the operating system, applied security patches, running a scheduled antivirus scan of the device, etc. In some embodiments, processing logic can detect user activity by monitoring the applications (and/or other components) hosted by the user device.

As another example, processing logic can determine the risk level on a predetermined schedule (in addition to or instead of in response to a triggering event). The predetermined schedule can be, for example, every three minutes. In some embodiments, the predetermined schedule can vary based on whether the user device is actively being used by a user. For example, while a user is actively using the user device, the predetermined schedule can be every two minutes. While the user is not actively using the user device, the predetermined schedule can be every sixty minutes.

In some embodiments, the risk level can be based on a risk score. Thus, in some embodiments, processing logic determines a risk score for the user device by calculating an average of the vulnerability-related metrics. Each vulnerability-related metric can be weighted by a corresponding weighting value. Processing logic can then determine the risk level based on the calculated risk score. In some embodiments, each risk level can correspond to a range of risk scores. As an illustrative example, a risk level of very low can correspond to risk scores between 0 and 20 (inclusive), a risk level of low can correspond to risk scores between 21 and 40 (inclusive), a risk level of medium can correspond to risk scores between 41 and 60 (inclusive), a risk level of high can correspond to risk scores between 61 and 80 (inclusive), and a risk level of severe can correspond to risk scores between 81 and 100 (inclusive). In this example, the vulnerability-related metrics can be on a scale of 0-100, where 100 indicates the most severe vulnerabilities. It should be noted that other scales and ranges can be used to determine the risk score and/or risk level.

At block 330, processing logic determines whether the risk level satisfies a criterion. In some embodiments, the criterion is satisfied if the risk level is above a threshold. In some embodiments, the criterion is satisfied if the risk score is above a threshold. As an illustrative example, processing logic can determine that the risk level satisfies the criterion if the risk level is medium, high, or severe. If the criterion is not satisfied, processing logic can proceed to block 310 and collect additional and/or update vulnerability-related metrics. If the criterion is satisfied, processing logic proceeds to block 340.

At block 340, processing logic performs a security-based action associated with the user device. In some embodiments, the security-based action can include, for example, sending a first notification to the user of the user device (e.g., indicating the risk level of the user device), sending a second notification to an application running on the user device, and/or sending a third notification to a second user device connected to the user device.

In some embodiments, processing logic can send a request to a second user device. For example, the request can be a request to access the second user device, and or a request to share data with the second user device. Processing logic can receive, from the second user device, a second request requesting the risk level of the user device. Processing logic can provide, to the second user device, the risk level of the user device. In some embodiments, processing logic can provide the risk level of the user device to the second user device in conjunction with (or as part of) the request. Processing logic can receive, from the second user device, a notification of whether the request has been granted or denied in view of the risk level of the user device. As an illustrative example, the second user device can deny the request of the user device if the risk level is high or severe.

In some embodiments, processing logic can receive, from a second user device, a request to access the user device. For example, the request can be a request to share data with the user device, or a request to access the user device. In some embodiments, the request can include a second risk level of the second user device. In some embodiments, processing logic can request the second risk level of the second user device, e.g., in response to receiving the request to access the user device. Processing logic can then determine whether the second risk level of the second user device satisfies a second criterion. The second criterion can be satisfied if the second risk level of the second user device is above a threshold. For example, processing logic can determine that the second risk level of the second user device satisfies the second criterion if the second risk level is high or severe. In response to determining that the second risk level of the second user device satisfies the second criterion, processing logic can deny the request from the second user device to access the user device.

In some embodiments, the first criterion and/or the second criterion can be defined by the manufacturer of the user device 102A-N, an organization supporting the user device 102A-N, and/or a user of the user device 102A-N. For example, the user of user device 102A-N can set a risk level threshold (e.g., high), or a risk score threshold (e.g., 70), and if the risk level of the user device is above the set risk level threshold, processing logic can perform a security-based action (e.g., prevent the user device from accessing other devices, provide a pop-up notification requesting that the user acknowledge the risk level before proceeding with the request, etc.). The first criterion and/or the second criterion can be defined upon device initialization, and/or upon factory reset.

FIG. 4 is a block diagram illustrating an exemplary computer system 400, in accordance with at least one embodiment of the present disclosure. The computer system 400 can correspond to server 130, security platform 105, and/or user devices 102A-N in FIG. 1. The machine can operate in the capacity of a server or an endpoint machine in an endpoint-server network environment, or as a peer machine in a peer-to-peer (or distributed) network environment. The machine can be a television, a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 400 includes a processing device (processor) 402, a main memory 404 (e.g., volatile memory, read-only memory (ROM), flash memory, dynamic random access memory (DRAM) such as synchronous DRAM (SDRAM), double data rate (DDR SDRAM), or DRAM (RDRAM), etc.), a static memory 406 (e.g., non-volatile memory, flash memory, static random access memory (SRAM), etc.), and a data storage device 416, which communicate with each other via a bus 430.

Processor (processing device) 402 represents one or more general-purpose processing devices such as a microprocessor, central processing unit, or the like. More particularly, the processor 402 can be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 402 can also be one or more special-purpose processing devices such as an application specific integrated circuit (ASIC), a field programmable gate array (FPGA), a digital signal processor (DSP), network processor, or the like. The processor 402 is configured to execute instructions 426 (e.g., for measuring the risk level of a device) for performing the operations discussed herein.

The computer system 400 can further include a network interface device 408. The computer system 400 also can include a video display unit 410 (e.g., a liquid crystal display (LCD) or a cathode ray tube (CRT)), an input device 412 (e.g., a keyboard, and alphanumeric keyboard, a motion sensing input device, touch screen), a cursor control device 414 (e.g., a mouse), and a signal generation device 418 (e.g., a speaker).

The data storage device 416 can include a non-transitory machine-readable storage medium 424 (also computer-readable storage medium) on which is stored one or more sets of instructions 426 (e.g., for measuring the risk level of a device) embodying any one or more of the methodologies or functions described herein. The instructions can also reside, completely or at least partially, within the main memory 404 and/or within the processor 402 during execution thereof by the computer system 400, the main memory 404 and the processor 402 also constituting machine-readable storage media. The instructions can further be transmitted or received over a network 420 via the network interface device 408.

In one implementation, the instructions 426 include instructions for measuring the risk level of a device, e.g., based on vulnerability-related metrics associated with applications hosted by the device. While the computer-readable storage medium 424 (machine-readable storage medium) is shown in an exemplary implementation to be a single medium, the terms “computer-readable storage medium” and “machine-readable storage medium” should be taken to include a single medium or multiple media (e.g., a centralized or distributed database, and/or associated caches and servers) that store the one or more sets of instructions. The terms “computer-readable storage medium” and “machine-readable storage medium” shall also be taken to include any medium that is capable of storing, encoding or carrying a set of instructions for execution by the machine and that cause the machine to perform any one or more of the methodologies of the present disclosure. The terms “computer-readable storage medium” and “machine-readable storage medium” shall accordingly be taken to include, but not be limited to, solid-state memories, optical media, and magnetic media.

Reference throughout this specification to “one implementation,” or “an implementation,” means that a particular feature, structure, or characteristic described in connection with the implementation is included in at least one implementation. Thus, the appearances of the phrase “in one implementation,” or “in an implementation,” in various places throughout this specification can, but are not necessarily, referring to the same implementation, depending on the circumstances. Furthermore, the particular features, structures, or characteristics may be combined in any suitable manner in one or more implementations.

To the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), software, a combination of hardware and software, or an entity related to an operational machine with one or more specific functionalities. For example, a component may be, but is not limited to being, a process running on a processor (e.g., digital signal processor), a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers. Further, a “device” can come in the form of specially designed hardware; generalized hardware made specialized by the execution of software thereon that enables hardware to perform specific functions (e.g., generating interest points and/or descriptors); software on a computer readable medium; or a combination thereof.

The aforementioned systems, circuits, modules, and so on have been described with respect to interact between several components and/or blocks. It can be appreciated that such systems, circuits, components, blocks, and so forth can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but known by those of skill in the art.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Finally, implementations described herein include collection of data describing a user and/or activities of a user. In one implementation, such data is only collected upon the user providing consent to the collection of this data. In some implementations, a user is prompted to explicitly allow data collection. Further, the user may opt-in or opt-out of participating in such data collection activities. In one implementation, the collected data is anonymized prior to performing any analysis to obtain any statistical patterns so that the identity of the user cannot be determined from the collected data.

What is claimed is:

1. A method comprising:
collecting, by a processor of a user device of a user, vulnerability-related metrics of a plurality of applications hosted by the user device;
determining, by the processor of the user device and based on the vulnerability-related metrics of the plurality of applications hosted by the user device, a risk level of the user device; and
responsive to determining that the risk level satisfies a criterion, performing, by the processor of the user device, a security-based action associated with the user device.

2. The method of claim 1, wherein determining the risk level of the user device comprises:
determining a risk score by calculating an average of the vulnerability-related metrics, each vulnerability-related metric weighted by a corresponding weighting value; and
determining the risk level of the user device based on the risk score.

3. The method of claim 1, further comprising:
sending a request to a second user device;
receiving, from the second user device, a second request requesting the risk level of the user device;
providing, to the second user device, the risk level of the user device; and
receiving, from the second user device, a notification of whether the request has been granted or denied in view of the risk level of the user device.

4. The method of claim 1, further comprising:
receiving, from a second user device, a request to access the user device, wherein the request comprises a second risk level of the second user device; and
responsive to determining that the second risk level of the second user device satisfies a second criterion, denying the request from the second user device to access the user device.

5. The method of claim 1, wherein the vulnerability-related metrics comprise at least one of: identified current vulnerabilities associated with the user device, a current location of the user device, network activity associated with the user device, or one or more websites accessed on the user device.

6. The method of claim 1, wherein the security-based action comprises at least one of: sending a first notification to the user of the user device, sending a second notification to an application running on the user device, or sending a third notification to a second user device connected to the user device.

7. The method of claim 1, wherein the risk level of the user device is determined in response to a triggering event.

8. A system comprising:
a memory device; and
a processing device coupled to the memory device, the processing device to perform operations comprising:
collecting vulnerability-related metrics of a plurality of applications hosted by a user device of a user;
determining, based on the vulnerability-related metrics of the plurality of applications hosted by the user device, a risk level of the user device; and
responsive to determining that the risk level satisfies a criterion, performing a security-based action associated with the user device.

9. The system of claim 8, wherein determining the risk level of the user device further comprises:
determining a risk score by calculating an average of the vulnerability-related metrics, each vulnerability-related metric weighted by a corresponding weighting value; and
determining the risk level of the user device based on the risk score.

10. The system of claim 8, wherein the operations further comprise:
sending a request to a second user device;
receiving, from the second user device, a second request requesting the risk level of the user device;
providing, to the second user device, the risk level of the user device; and
receiving, from the second user device, a notification of whether the request has been granted or denied in view of the risk level of the user device.

11. The system of claim 8, wherein the operations further comprise:
receiving, from a second user device, a request to access the user device, wherein the request comprises a second risk level of the second user device; and
responsive to determining that the second risk level of the second user device satisfies a second criterion, denying the request from the second user device to access the user device.

12. The system of claim 8, wherein the vulnerability-related metrics comprise at least one of: identified current vulnerabilities associated with the user device, a current location of the user device, network activity associated with the user device, or one or more websites accessed on the user device.

13. The system of claim 8, wherein the security-based action comprises at least one of: sending a first notification to the user of the user device, sending a second notification to an application running on the user device, or sending a third notification to a second user device connected to the user device.

14. A non-transitory computer readable storage medium comprising instructions for a server that, when executed by a processing device, cause the processing device to perform operations comprising:
collecting vulnerability-related metrics of a plurality of applications hosted by a user device of a user;
determining, based on the vulnerability-related metrics of the plurality of applications hosted by the user device, a risk level of the user device; and
responsive to determining that the risk level satisfies a criterion, performing a security-based action associated with the user device.

15. The non-transitory computer readable storage medium of claim 14, wherein determining the risk level of the user device further comprises:
determining a risk score by calculating an average of the vulnerability-related metrics, each vulnerability-related metric weighted by a corresponding weighting value; and
determining the risk level of the user device based on the risk score.

16. The non-transitory computer readable storage medium of claim 14, wherein the operations further comprise:
sending a request to a second user device;
receiving, from the second user device, a second request requesting the risk level of the user device;
providing, to the second user device, the risk level of the user device; and
receiving, from the second user device, a notification of whether the request has been granted or denied in view of the risk level of the user device.

17. The non-transitory computer readable storage medium of claim 14, wherein the operations further comprise:
receiving, from a second user device, a request to access the user device, wherein the request comprises a second risk level of the second user device; and
responsive to determining that the second risk level of the second user device satisfies a second criterion, denying the request from the second user device to access the user device.

18. The non-transitory computer readable storage medium of claim 14, wherein the vulnerability-related metrics comprise at least one of: identified current vulnerabilities associated with the user device, a current location of the user device, network activity associated with the user device, or one or more websites accessed on the user device.

19. The non-transitory computer readable storage medium of claim 14, wherein the security-based action comprises at least one of: sending a first notification to the user of the user device, sending a second notification to an application running on the user device, or sending a third notification to a second user device connected to the user device.

20. The non-transitory computer readable storage medium of claim 14, wherein the risk level of the user device is determined in response to a triggering event.
